(19) United States
(12) Patent Application Publication
(10) Pub. No.: US 2016/0213452 A1
(43) Pub. Date: Jul. 28, 2016

(54) Methods and Apparatus for Implants and Reconstruction

(71) Applicant: Earl Wayne Simmons, JR., San Antonio, TX (US)

(72) Inventor: Earl Wayne Simmons, JR., San Antonio, TX (US)

(21) Appl. No.: 15/003,523

(22) Filed: Jan. 21, 2016

Related U.S. Application Data
(60) Provisional application No. 62/106,655, filed on Jan. 22, 2015.

(51) Int. Cl. A61C 8/00; A61C 1/08

(52) U.S. Cl. CPC A61C 8/0077; A61C 8/0068; A61C 8/0069; A61C 8/006; A61C 8/0089; A61C 1/084

(57) ABSTRACT

An implant apparatus and method of reconstruction are provided in which an anchor (16) implanted into bone, and an eccentric base (18) is coupled to the anchor (16) with a coupler (20). A fixture, such as a dental fixture, may be coupled to the base (18).

### CROSS-REFERENCE TO RELATED APPLICATION AND PRIORITY INFORMATION

This application claims the benefit of co-pending, prior filed U.S. provisional application no. 62/106,655 entitled “Methods and Apparatus for Implants and Reconstruction”, filed Jan. 22, 2015.

### TECHNICAL FIELD OF THE INVENTION

This invention relates generally to bone implants, and in particular to methods and apparatus for implants and reconstruction.

### BACKGROUND OF THE INVENTION

In recent years, the use of dental implants has become widespread. Concentrically shaped implants are the most common, and offer relatively easy installation. Their round shape allows the use of conventional drills and screwing techniques. However, well known functional, hygienic, and aesthetic problems can be associated with concentric implants.

Eccentrically shaped implants, which more closely match natural teeth shapes in cross section, may reduce such problems. However, eccentric implants present their own difficulties.

For example, they generally require more complex osteotomies in preparation for the implants. And, if an implant site is not properly prepared, the implant may not integrate with the jawbone with sufficient strength to provide adequate stability. As examples of poor implant sites, sites may be too large, or too deep, or too shallow, or too tapered, or mismatched to the shape of the implant, leading to voids or insufficient jawbone-to-implant surface contact, or to hygienic or aesthetic problems. Relatedly, if the implant site is too deep, resorbed, vertically depressed from bone loss, or too tapered, there may be insufficient bone mass available for adequately securing an implant anchor.

Furthermore, eccentric implants may employ multiple components, and the fit between these components (as well as to the bone) is important. The junctions between the components themselves and to bone must not result in voids or allow movement, which can lead to implant failure.

Therefore, a need has arisen for improved methods and apparatus for dental implants and reconstruction that reduce or eliminate these problems. Similar problems and needs exist in general orthopedics as well.

### SUMMARY OF THE INVENTION

In accordance with the teachings of the present invention, methods and apparatus for implants and reconstruction are provided which eliminate or substantially reduce the problems associated with prior art systems. Moreover, although the present invention will be discussed in terms of a dental application, it has application in orthopedics in general.

In particular, an implant apparatus is provided that comprises an anchor adapted to be set in bone, an eccentric base in contact with the anchor, and a coupler adapted to engage with the anchor and the base to couple the anchor and the base.

In some embodiments, the coupler is a screw with a tapered head, and wherein the base includes a tapered internal surface that matchingly engages with the tapered head. In other embodiments the coupler is a screw with a flat sealing shoulder. Also, the anchor may comprise a head with a concave surface at a crown (or coronal) end.

In some embodiments, the base is an eccentric basket having a rim. It may also include a convex anchor end for matching engagement with the anchor.

In some embodiments the base comprises a male hexagonal member, and the anchor includes a female hexagonal bore for receiving the male hexagonal member. The coupler may pass through these hexagonal features.

Also provided is a method of implanting an implant apparatus, which comprises implanting an anchor into a bone, implanting an eccentrically shaped base into the bone at the coronal end of the anchor, and coupling the base to the anchor. The method may further comprise working a cutting instrument above the anchor, to cut away bone to form an eccentric osteotomy site into which the eccentrically shaped base is implanted. In a particular embodiment of the method, the coronal end of the anchor serves as a platform for working the cutting instrument.

Important technical advantages are provided by the present invention. In particular, a stable, secure implant is provided by using a coupler to couple a base to an anchor that is already set in bone. Also, eccentric osteotomy sites may be more effectively developed with the present invention, because the anchor provides a stable platform for working a cutting instrument to create the desired osteotomy shape.

### BRIEF DESCRIPTION OF THE DRAWINGS

Reference is made in the description to the following briefly described drawings, which are not drawn to scale, with certain features enlarged for clarity, in which like reference numerals indicate like features:

FIG. 1 illustrates one embodiment of an implant according to the teachings of the present invention;

FIG. 2 illustrates one embodiment of an anchor according to the teachings of the present invention;

FIG. 3 illustrates an exploded cross sectional view of one embodiment of an implant according to the teachings of the present invention;

FIGS. 4-7 illustrate steps of developing an osteotomy site according to the teachings of the present invention; and

FIG. 8 illustrates one embodiment of a base and coupler according to the teachings of the present invention.

### DETAILED DESCRIPTION OF THE INVENTION

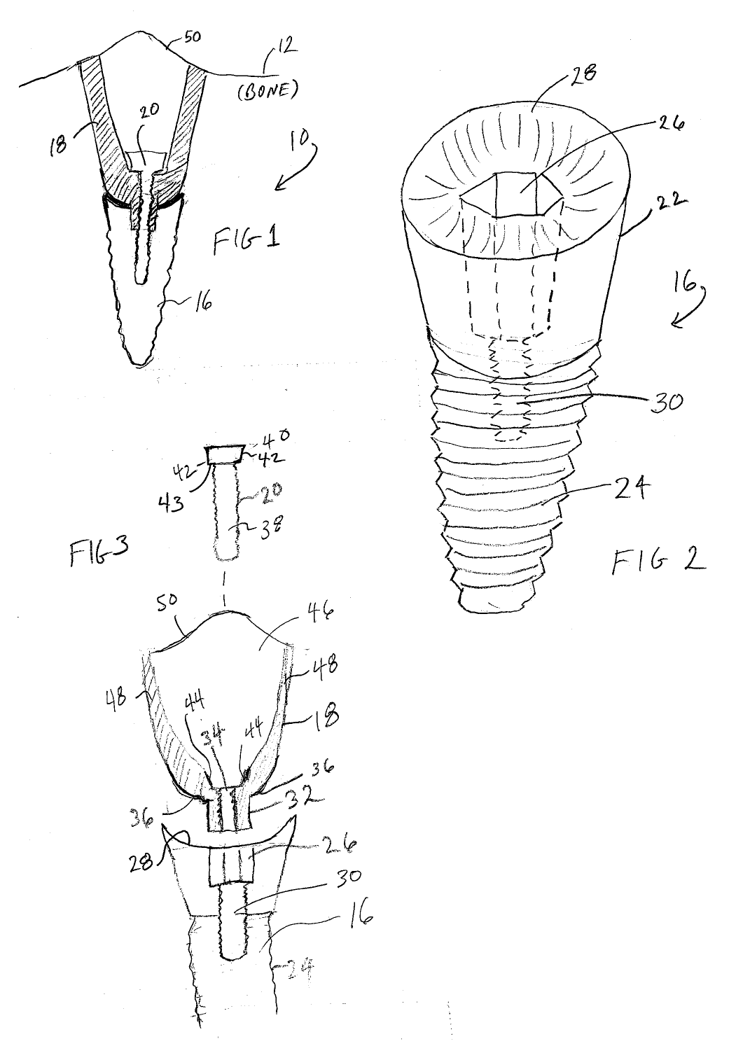

FIG. 1 illustrates one embodiment of a dental implant 10 according to the teachings of the present invention. Implant 10 is implanted into bone 12 at site 14. Preparation of site 14 will be described below. Implant 10 includes anchor 16, base 18, and coupler 20. Anchor 16 is set into the bone, and then base 18 is coupled to the anchor 16 with coupler 20. Anchor 16, base 18, and coupler 20 may be made of any suitable material, including, without limitation surgical grade metals. The components in contact with bone, such as anchor 16 and base 18, are preferably made of surgical grade Titanium or Zirconium, although any suitable material, such as, without limitation, sapphire, may be used.

FIG. 2 illustrates a particular embodiment of anchor 16. As shown, anchor 16 includes a head 22 threaded section 24. The threaded section 24 allows for osseointegration by screwing. However, any other suitable features, such as, without limitation, barbs, ribs, waists, or inverted ribs, may be used, and the anchor inserted by tapping, for example. It should be understood that the scope of the present invention, as described in connection with all embodiments herein, includes anchors with or without such features.

Head 22 is preferably of wider diameter than section 24, though it need not be. In one embodiment, Also, the sidewalls of head 22 may be tapered so that it is wider at the edges of its top surface 28 (crown end) than where it is adjacent to the threaded section 24. Indeed, no distinct head 22 is needed, and it may be a continuation of the threaded section 24. A hexagonal bore 26 through surface 28 facilitates use of a hexagonal driving tool to screw in the anchor 16. However, any suitable feature that facilitates driving may be used, or no feature at all, for example where the anchor is tapped into place. Also, an internal female threaded bore 30 extends into the anchor 16.

Surface 28 is preferably concave, although any contour may be used.

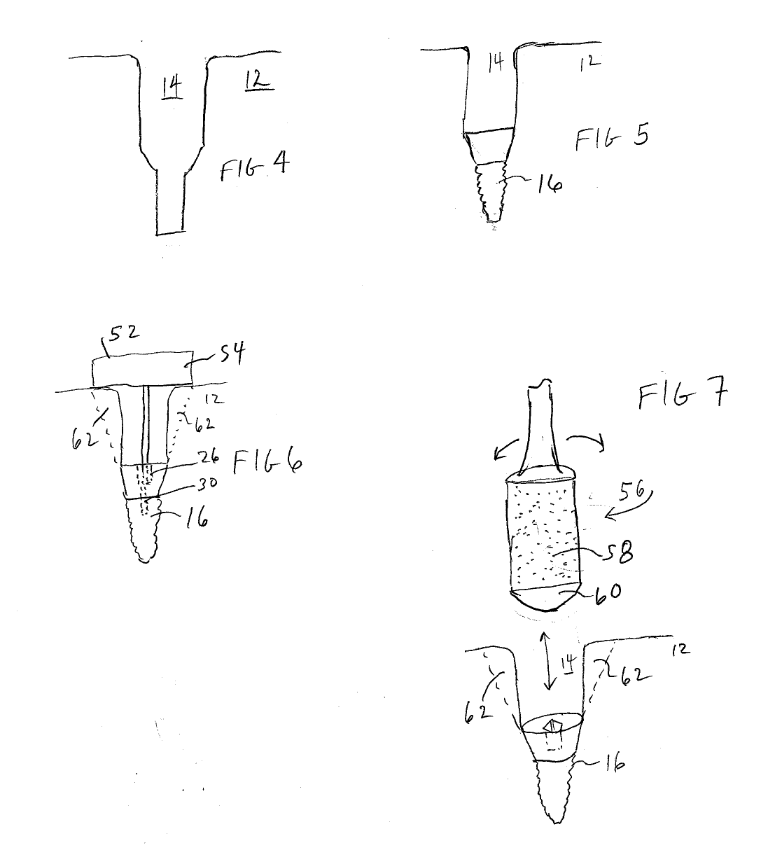

As shown in the cross-sectional exploded view of FIG. 3, base 18 includes a male hexagonal member 32 for engagement with the hexagonal bore 26 of anchor 16. Such a feature prevents rotation between the anchor 16 and base 18. Member 32 includes an internal pass through bore 34 through which coupler 20 passes. Bore 34 may be threaded, although it need not be. Furthermore, the implant end of base 18 (designated as surface 36) is contoured to matchingly engage with surface 28 of anchor 16. Thus, for example, where surface 28 is concave, surface 36 is preferably convex. This matching ensures that the junction of the base 18 and anchor 16 is secure, stable, and substantially without voids. Any suitable contour, including a flat surface, may be used.

Coupler 20 may be a prosthetic capture screw, and includes a threaded section 38 and a head 40. To couple base 18 to anchor 16 (at surfaces 28 and 36), threaded section 38 passes through bore 34 of base 18 to engage with threaded bore 30 of anchor 16. As discussed, bore 34 may be threaded to better secure the components. Head 40 is wider than bore 34, and may include a feature, such as a hexagonal bore, to facilitate driving into anchor bore 30. Also, the sidewalls 42 of head 40 may be tapered so that it is wider at its top (crown end) than where it is adjacent to section 38. The contour of surface 44 of the internal sidewall of base 18 (near the implant end) is matched to the contour of head 40, to create a substantially liquid tight seal at the bottom of base 18, and to help ensure that the junction between coupler 20 and base 18 is secure, stable, and substantially without voids. Also, with or without the tapered sidewall 44, the diameter of the anchor end of head 40 may be greater than that of threaded section 38 (as shown by flat surface 43) for sealing against the base 18. Although a particular embodiment for coupler 20 has been described, any suitable mechanism may be used to couple base 18 to anchor 16.

Although bore 26 and member 32 are illustrated as hexagonal features, any suitable approach may be used to engage anchor 16 and base 18 and to, preferably, prevent rotation between them. As one non-limiting example, these features may be reversed, such that the female feature is on the base 18, and the male feature on the anchor 16. Furthermore, no such members are needed, for example, and without limitation, in embodiments where anchor 16 is set in place by tapping and needs no driving bore. Where no member 32 is used, bore 34 passes through the implant end of base 18 to facilitate its coupling to anchor 16.

Base 18 may be any shape suitable to the application, and upon or in which an abutment or crown may be formed. Base 18 is preferably in the shape of an eccentric basket (which may be as deep or shallow as is suited to the application), and thus includes a recess 46 bounded by its sidewall 48. The exterior (bone side) of sidewall 48 may be smooth, or may include features for facilitating osseointegration, such as, without limitation, a rough surface, ribs, waists, or inverted ribs.

The crown end (or edge) of sidewall 48 is a rim 50. The shape of rim 50 may be any suitable shape, and preferably matches the eccentric emergence profile of the natural tooth being replaced. Thus, for example, if a maxillary incisor is being replaced, from a top view, the rim 50 may have a soft triangular shape. Furthermore, the rim 50 need not be planar in cross section, but again preferably matches the emergence profile of natural teeth. Thus, for example from a front view, it may appear to have the shape of a saddle. In typical applications, the base 18 is about 4 mm to 6 mm from the crown end (rim 50) to the implant end. However, it can be much longer or shorter, depending on the needs of the application.

Following is a description of steps for installing an implant according to the present invention. A primary osteotomy hole is formed in bone 12 at site 14. In a typical example, the site is prepared with a 2 mm diameter round twist drill. The site is expanded, for example with a step drill (2 mm diameter smooth shank for approximately 5 mm) at which level the drill expands to the desired minimum diameter of the eccentric base 18 (abutment basket) to be used. FIG. 4 illustrates the osteotomy site 14 at this stage.

As shown in FIG. 5, the anchor 16 is surgically secured to the bottom of the osteotomy site 14 so that the head 22 is approximately level with the point where the step drill expanded the diameter of the site. In a typical (but non-limiting) example, the surface 28 of anchor 16 may be approximately 5 to 7 mm from the crest of the ridge of bone in which it is implanted.

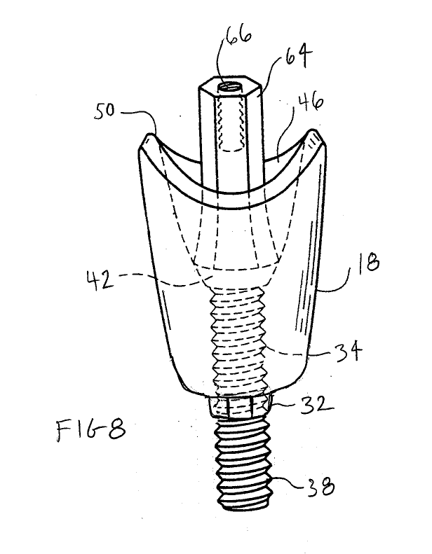

To further prepare the osteotomy site 14 for an eccentric base 18 (also called an abutment basket), some or all of the following steps may be followed. As shown in FIG. 6, a template instrument 52 is aligned by insertion into bore 26 or 30. Such an instrument includes an eccentric template 54 shaped to match the outline of the abutment basket 18 that is to be coupled to the anchor 16. The template allows scribing (along the template) of the bony crest to mark out the boundary to which the site should be expanded to accommodate the abutment basket. Once the bony crest is scribed, the template instrument is removed.

Next, the osteotomy site is expanded to match the shape of the basket abutment to be implanted, and the scribing discussed above, though not necessary, helps to guide the surgeon in this expansion process. Any suitable instrument may be used to expand the site.

As shown in slightly perspective cut away view FIG. 7, one particular example of an instrument for expanding the osteotomy site is burr 56, which includes a cutting surface 58 and a smooth tip 60. The cutting surface 58 may be any suitable surface, including, without limitation, one that is roughened, coated with diamond or other grit, or which includes cutting features. The burr 56 is inserted into the site 14 and worked such that cutting surface 58 cuts away bone sections 62 of bone 12 to create the desired shape to accommodate the eccentric base. The smooth tip 60 can be worked against surface 28 of anchor 16, which acts as a vertical stop for the burr 56 as well as a solid base (or platform) on which to rock or toggle the burr. In a preferred embodiment, surface 28 is concave, and the tip 60 is convex, thus creating a stable working platform for more accurately developing the osteotomy. Any suitable motion, including, without limitation, rotation, reciprocation, vibration, and/or toggling (and/or any other suitable motion) can be used to work the burr, so as to cut out bone above the anchor 16 until the desired eccentric shape has been created.

Although it is preferred to expand the osteotomy site after inserting anchor 16, the expansion may occur before insertion of the anchor.

After this site preparation, the base 18 is implanted into the site 14, with the member 32 of base 18 engaging bore 26 of anchor 16. In the preferred example, member 32 and bore 26 are hexagonal features, and thus, if rim 50 is eccentric, it is important that anchor 16 be turned to the proper alignment so that, upon insertion of member 32, the base 18 is properly indexed to the correct orientation.

Coupler 20 is then employed to couple anchor 16 and base 18. To do so, coupler 20 may be driven through bore 34 (whether threaded or otherwise) of base 18 into threaded bore 30 of anchor 16. Surface 42 of coupler 20 seats against surface 44 of base 18.

FIG. 8 illustrates a particular embodiment of coupler 20 and base 18 (for clarity, anchor 16 is not shown). As shown, head 40 of coupler 20 may be an elongated hexagonal head 64 that facilitates driving and for attachment of an abutment. Such an abutment may be attached in any suitable way, including, without limitation, by threading into threaded bore 66 in head section 64. A crown, or other dental fixture, may be cemented, glued, screwed, or otherwise affixed to the abutment and base 18. Although particular embodiments have been illustrated, head 40 may be shaped in any suitable way, for example, without limitation, to accommodate drilling, to form an abutment for attachment of a crown, or to accommodate an abutment to be secured to the head.

In another embodiment, a crown may be affixed directly to the base 18 or head 40, and no abutment is necessary.

The recess 46 of abutment basket (base) 18 allows for excellent bonding or seating between a crown and the base 18. The recess may be relatively thin, or as deep as needed, or omitted altogether. The rim 50 (or crown end of the base) should be, although is not required to be, substantially flush with the jawbone. Thus, preferably the base 18 is substantially set within the jawbone.

In some applications it may be appropriate to use a material, for example, but not by way of limitation, metal, plastic, ceramic, or glass-filled resin, to build an appropriate abutment for fixation of a crown or other dental fixture. The recess 46 provides an excellent space for building such a site, and allows for a porcelain-metal interface, or a porcelain-porcelain interface, between the crown and base 18.

These listed ways of affixing the crown are exemplary only, and any suitable approach for affixing a crown may be used.

As part of the present invention, a set of standard shaped devices may be prepared for the professional to choose from. For example, the set may have variously shaped bases for bicuspids, molars, canines, and incisors, and different sizes for each shape, along with variously sized anchors and couplers and burrs. From this set, the professional chooses the parts that are appropriate for the particular case. As an alternative, the professional may have the devices custom made, after analyzing the case.

Throughout the examples illustrated herein, the components may include internal female or external male hexagonal elements for driving in and out. However, other approaches can be used for driving the components. Also, the devices may be tapped into place.

In this description, features in each example can be interchanged with features in other examples. Also, certain materials, sizes, and approaches for fixing certain parts to others have been illustrated. Others can be used without departing from the intended scope of the present invention.

And, in general, although the present invention has been described in detail, it should be understood that various changes, alterations, substitutions, additions, and modifications could be made without departing from the intended scope of the invention, as defined in the following claims.

What is claimed is:

1. An implant apparatus, comprising:
an anchor adapted to be set in bone;
an eccentric base in contact with the anchor; and
a coupler adapted to engage with the anchor and the base to couple the anchor and the base.

2. The apparatus of claim 1, wherein the coupler is a screw with a tapered head, and wherein the base includes a tapered internal surface that matchingly engages with the tapered head.

3. The apparatus of claim 1, wherein the anchor comprises a head with a concave surface at a coronal end.

4. The apparatus of claim 1, wherein the eccentric base comprises an eccentric basket having a rim.

5. The apparatus of claim 1, wherein:
the base comprises a male hexagonal member; and
the anchor includes a female hexagonal bore for receiving the male hexagonal member.

6. A method of implanting an implant apparatus, comprising:
implanting an anchor into a bone;
implanting an eccentrically shaped base into the bone at the anchor; and
coupling the base to the anchor.

7. The method of claim 6, and further comprising working a cutting instrument above the anchor to cut away bone to form an eccentric osteotomy site into which the eccentrically shaped base is implanted.

8. The method of claim 7, wherein the anchor serves as a platform for working the cutting instrument.
